(19) United States
(12) Patent Application Publication
(10) Pub. No.: US 2009/0061926 A1
(43) Pub. Date: Mar. 5, 2009

(54) Cell Phone with Bluetooth Inside

(76) Inventor: Daniel Lee, Everett, WA (US)

Correspondence Address: WILSON DANIEL SWAYZE, JR., 3804 CLEARWATER CT., PLANO, TX, 75025, US

(21) Appl. No.: 11/848,592

(22) Filed: Aug. 31, 2007

(51) Int. Cl. H04M 1/02

(52) U.S. Cl. 455/556.1; 455/569.1

(57) ABSTRACT

A device for wireless communication includes a cell phone device for wireless communication and a Bluetooth device for wireless communication with the cell phone device. The Bluetooth device is detachedly connected to the cell phone device. The cell phone device includes a restricting device to hold the Bluetooth device, and the Bluetooth device includes an outwardly extending projection to cooperate with the restraining device. The cell phone device includes a release device to release the Bluetooth device by cooperating with the restraining device, and the Bluetooth device includes an ear member. The cell phone device includes a depression for holding the Bluetooth device, and the Bluetooth device includes a housing member. The Bluetooth device includes a connecting member for connecting the housing member with the ear member, and the Bluetooth device includes a microphone device.

### FIELD OF THE INVENTION

The present invention relates to the field of short distance wireless communications. More specifically, the present invention relates to a method of using a Bluetooth device to enable short distance wireless communication with a cell phone device.

### BACKGROUND

U.S. Pat. No. 6,255,800 to Bork discloses a mobile device charging cradle to enable short distance wireless communication between a personal computer and at least one other short distance wireless communication enabled electronic device. In a preferred embodiment of the invention, a short distance wireless radio (transceiver—Bluetooth enabled) and antenna are added to a charging cradle to produce a combination charging and short distance wireless communication enabled cradle which is coupled via a data cable to a personal computer. The short distance wireless communication enabled cradle enables a system in which a legacy architecture personal computer may communicate with other short distance RF communication enabled electronic devices. Such communication is enabled whether or not another RF communication enabled portable electronic device is coupled to the cradle. In another embodiment of the invention, a universal serial bus USB in a computer is used as a power source for the previously described cradle. In one embodiment, a data/power cable couples a computer having an external USB connector to the short distance wireless communication enabled cradle. The cable includes electronic circuitry for converting the voltage level supplied by the USB to a voltage level usable by the cradle—including its Bluetooth radio and any peripheral electronic device that may be coupled to the cradle.

U.S. Pat. No. 7,167,721 to Jung discloses a method of requesting emergency rescue in a mobile communication terminal having a Bluetooth device. The method comprises the steps of: computing position information of the terminal in case of emergency; switching into a sleep mode after computing the position information of the terminal; transmitting an emergency-informing packet containing the position information into the Bluetooth device after switching into the sleep mode; and executing by the Bluetooth device communication with another nearby Bluetooth device.

U.S. Pat. No. 7,231,181 to Kohli discloses a pen-type wireless transceiver for a mobile communication terminal using Bluetooth. The pen-type wireless transceiver includes a pen type body, an LED, a pattern type antenna, a speaker, an LCD display, a button unit, a battery, a microphone, a Bluetooth controller, an audio interface, a main board, a battery supervisor, a replaceable ballpoint ink container, a locking projection, threaded parts, a pen clip and a guard pad.

U.S. Pat. No. 7,190,954 to Wonak discloses A Bluetooth-wireless docking station for use with a Bluetooth-enabled cellular mobile handset, which docking station allows mobility to the cellular mobile handset rather than having to be fixed stationarily in the docking station, which docking station couples standard POTS telephone sets, or POTS-like telephone units, connected to in-premises wiring, to the cellular, or cellular like, network. The cellular mobile handset may be used to make or receive calls remote from the docking station, while the docking station communicates with the Bluetooth-enabled cellular mobile handset via a Bluetooth-wireless transceiver using Bluetooth-wireless air-interface protocol. A subscriber-line interface circuit, controlled by a microprocessor, couples the standard POTS telephone sets to the cellular mobile handset's transceiver whereby the phones may make or receive calls via the cellular, or cellular like, network, which subscriber line interface also provides loop current, ring signaling, dial tone, loop current detect, flash detection, DTMF conversion, and other central office functions to the telephone sets. As long as the cellular mobile handset is within range of the Bluetooth-wireless transceiver of the docking station, the telephones are connected to the cellular network, as long as the cellular mobile handset is not engaged in a call of its own. The same docking station is capable of accommodating and being paired with any of a wireless-enabled TDMA-based, GSM-based, CDMA-based, or AMPS-based standard transceiver.

These patents are incorporated by reference in there entirety.

### SUMMARY

A device for wireless communication includes a cell phone device for wireless communication and a Bluetooth device for wireless communication with the cell phone device. The Bluetooth device is detachedly connected to the cell phone device.

The cell phone device includes a restricting device to hold the Bluetooth device, and the Bluetooth device includes an outwardly extending projection to cooperate with the restraining device.

The cell phone device includes a release device to release the Bluetooth device by cooperating with the restraining device, and the Bluetooth device includes an ear member.

The cell phone device includes a depression for holding the Bluetooth device, and the Bluetooth device includes a housing member.

The Bluetooth device includes a connecting member for connecting the housing member with the ear member, and the Bluetooth device includes a microphone device.

The Bluetooth device includes a front speaker member, and the cell phone device includes charging connector.

The Bluetooth device includes a charging connection member for cooperating with the charging connector of the cell phone device, and the cell phone device includes a control panel.

The cell phone device includes an internal screen, and the cell phone includes an external screen.

The cell phone may be a flip type or a slide type, and the Bluetooth device includes a extended microphone member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the cell phone and detachable Bluetooth device of the present invention;

FIG. 2 illustrates a front view of the cell phone and Bluetooth device attached to the cell phone;

FIG. 3 illustrates a side view of the cell phone of the present invention;

FIG. 4 illustrates a back view of the cell phone of the present invention;

FIG. 5 illustrates a top view of the cell phone of the present invention;

FIG. 6 illustrates a bottom view of the cell phone of the present invention;

FIG. 7 illustrates a top view of the Bluetooth device of the present invention;

FIG. 8 illustrates a bottom view of the Bluetooth device of the present invention;

FIG. 9 illustrates a side view of the Bluetooth device of the present invention;

FIG. 10 illustrates a front view of the Bluetooth device of the present invention;

FIG. 11 illustrates a rear view of the Bluetooth device of the present invention;

FIG. 12 illustrates a top view of another embodiment of the Bluetooth device of the present invention;

FIG. 13 illustrates a bottom view of the another embodiment of the Bluetooth device of the present invention;

FIG. 14 illustrates a front view of the Bluetooth device of the present invention;

FIG. 15 illustrates a rearview of the Bluetooth device of the present invention;

FIG. 16 illustrates a side view of the Bluetooth device of the present invention;

FIG. 17 illustrates a front view of another cell phone device of the present invention;

FIG. 18 illustrates a side view of the cell phone device of the present invention;

FIG. 19 illustrates a front view of another cell phone device of the present invention;

FIG. 20 illustrates a side view of the cell phone device of the present invention;

FIG. 21 illustrates a closed side view of another cell phone device of the present invention;

FIG. 21 illustrates a opened side view of the cell phone device of the present invention;

FIG. 23 illustrates a closed front view of the cell phone of the present invention;

FIG. 24 illustrates a opened front view of the cell phone of the present invention;

FIG. 25 illustrates a front view a cell phone device with the detached Bluetooth device;

FIG. 26 illustrates a front view of the cell phone device with the blue tooth device attached.

### DETAILED DESCRIPTION

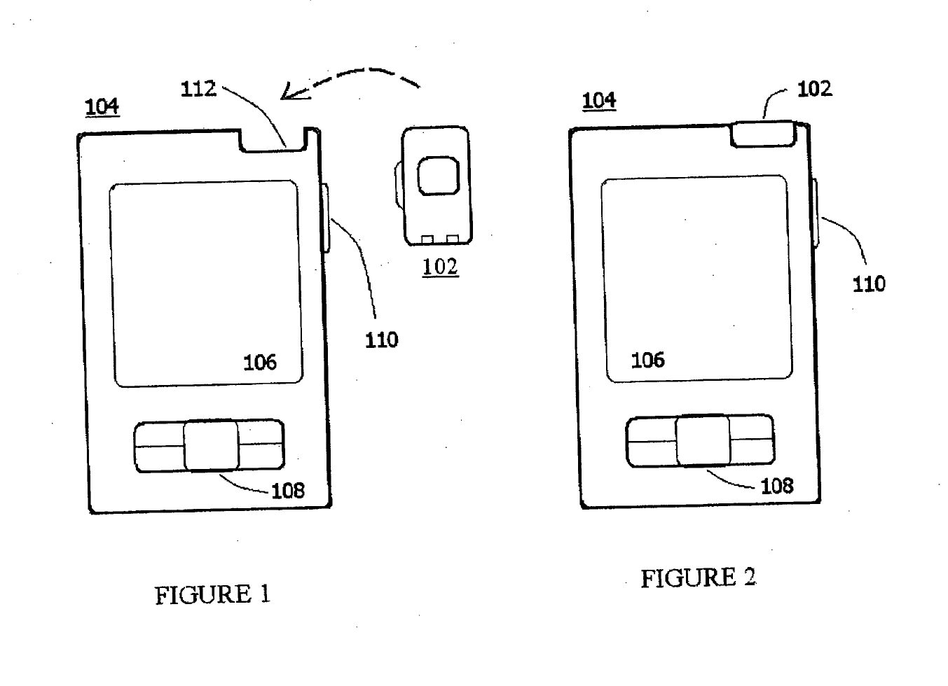

FIG. 1 illustrates a detachable Bluetooth device 102 which can be attached to a cell phone device 104 and the detachable Bluetooth device 102 operates in conjunction with the cell phone device 104 in order to provide communication for the user. The detachable Bluetooth device 102 wirelessly communicates with the cell phone device 104 which in turn wirelessly connects with a network for wireless communication. The cell phone device 104 may include a screen 106 to display information relevant to the cell phone device 104 and the detachable Bluetooth device 102. Additionally, the cell phone device 104 may include a control panel 108 which may include buttons which may be used to control the cell phone device 102 for the detachable Bluetooth device 102 and may include a release device 110 which may be in the form of a button to release the detachable Bluetooth device 102 after it has been connected to the cell phone device 104. The housing member of the cell phone device 104 may include a depression 112 to aid in the release of the detachable Bluetooth device 102 from the cell phone device 104.

FIG. 2 illustrates the detachable Bluetooth device 102 which has been attached to and positioned in the cell phone device 104. If the release device 110 has been activated, for example by pressing the button, the detachable Bluetooth device 102 is released from the cell phone device 104, allowing the detachable Bluetooth device 102 to be operated by the user. FIG. 2 additionally illustrates the screen 106 and the control panel 108.

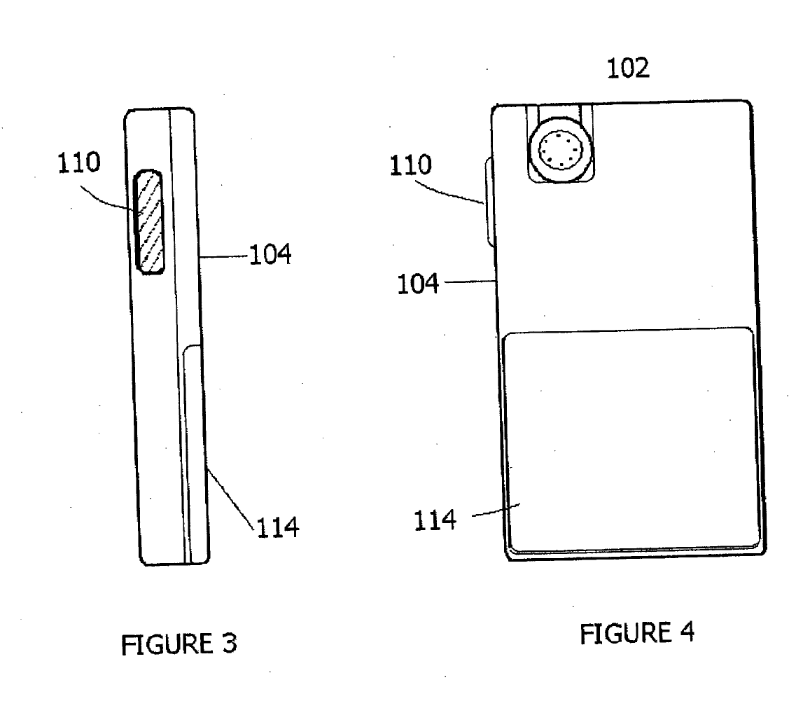

FIG. 3 illustrates a side view of the cell phone device 104 and shows the release device 110 for releasing the detachable Bluetooth device 102. FIG. 3 additionally illustrates a battery cover 114 for a battery to power the cell phone device 104.

FIG. 4 illustrates a back view of the cell phone device 104 and shows the release device 110 to release the detachable Bluetooth device 102 and the battery cover 114.

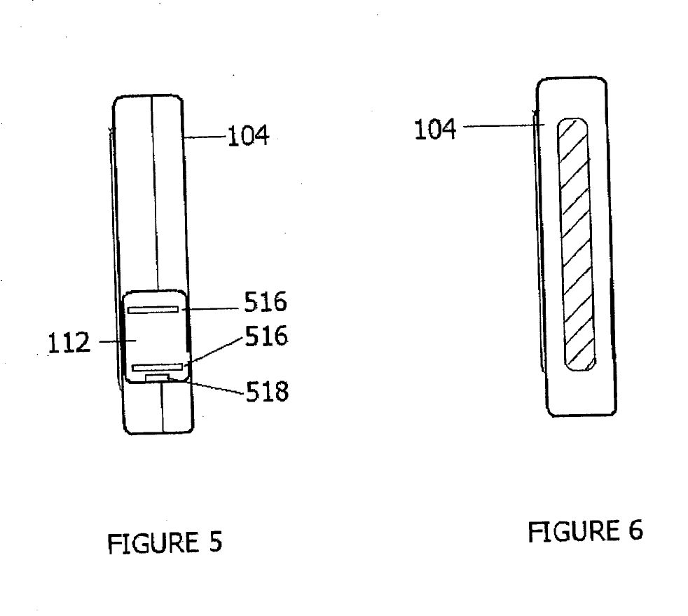

FIG. 5 illustrates a top view of the cell phone device 104 and shows the depression 112 of the cell phone device 114 to accept the detachable Bluetooth device 102. The bottom of the depression 112 includes a pair of charging connectors 516 to connect to the battery of the cell phone device 104 to charge the detachable Bluetooth device 102. FIG. 5 shows a restraining device 518 positioned in the side wall of the depression 112 to restrain or hold the detachable Bluetooth device 102 and the restraining device 518 cooperates with the release device 110 so that when the release device 110 is activated, the restraining device 518 releases the detachable Bluetooth device 102.

FIG. 6 illustrates the bottom of the cell phone device 104.

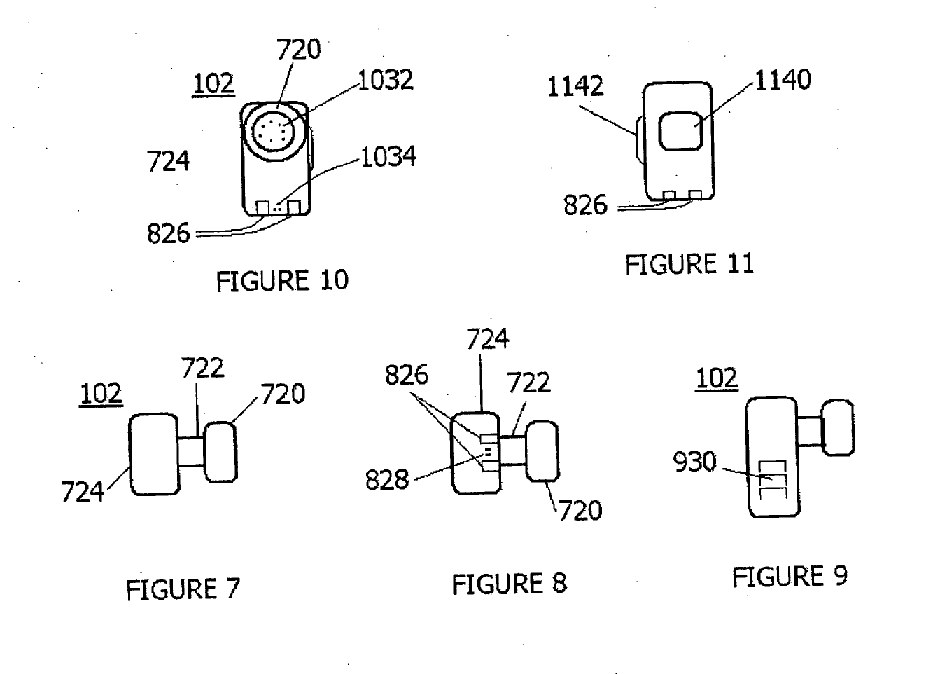

FIG. 7-11 illustrates some details of the detachable Bluetooth device 102. More particularly, FIG. 7 illustrates a top view of the detachable Bluetooth device 102 and illustrates an ear member 720 which may be attached to the ear and a connecting member of 722 to connect the ear member to the housing member 724.

FIG. 8 illustrates a bottom view of the detachable Bluetooth device 102 and illustrates the ear member 720, the connecting member 722 and the housing member 724. Additionally, FIG. 8 illustrates a charging connection member 826 to connect to the charging connector 516. FIG. 8 additionally illustrates a speaker member 828 to broadcast sound from the detachable Bluetooth device 102.

FIG. 9 illustrates a side view of the detachable Bluetooth device 102 and illustrates outwardly projecting member 930 to cooperate with the restraining device 518 to hold the detachable Bluetooth device 102 within the depression 112. FIG. 9 illustrates that the detachable Bluetooth device 102 may include multiple outwardly extending projections 930.

FIG. 10 illustrates a front view of the detachable Bluetooth device 102 and shows the ear member 720 and the housing member 724. The ear member 720 includes a front speaker member 1032 to transmit sounds to the user of the Bluetooth device 102. The charging connector member 826 extends from the bottom of the detachable Bluetooth device 102 to the front of the detachable Bluetooth device 102. FIG. 10 additionally illustrates a microphone device 1034 positioned between the charging connector member 826.

FIG. 11 illustrates a rearview of the detachable Bluetooth device 102 and illustrates the charging connecting member 826 extends from the bottom of the detachable Bluetooth device 102 to the back of the detachable Bluetooth device 102. FIG. 11 additionally illustrates an activation device 1140 which may be a button to activate the detachable Bluetooth device 102 so that the detachable Bluetooth device 102 can communicate with the cell phone device 104 and a volume control member 1142 for controlling the volume to the front speaker member 1032 so that the user can turn up or turn down the volume.

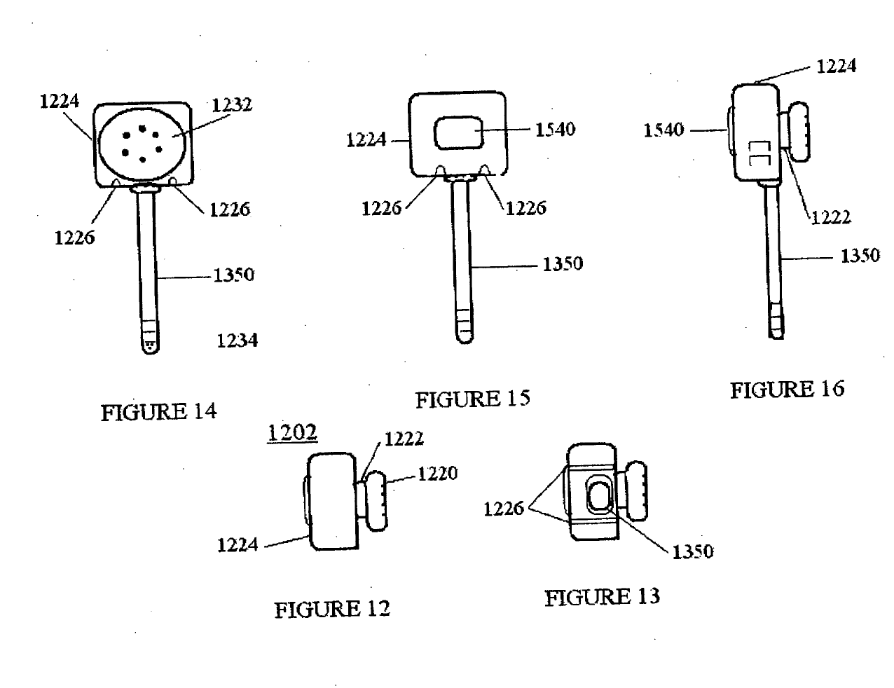

FIGS. 12-16 illustrate a alternative detachable Bluetooth device 1202. FIG. 12 illustrates a top view of the detachable Bluetooth device 1202 which is detachable from the cell phone device 104. FIG. 12 shows that the detachable Bluetooth device 1202 includes an ear member 1220, a connecting member 1222 to connect the ear member 1220 and the housing member 1224 which is connected to the connecting member 1222.

FIG. 13 illustrates a bottom view of the alternative detachable Bluetooth device 1202. FIG. 13 illustrates a charging connector member 1226 which extends across the bottom of the detachable Bluetooth device 1202 and the bottom and illustrates the extended microphone member 1350.

FIG. 14 illustrates a front view of the detachable Bluetooth device 1202 and shows a speaker member 1232 mounted on the ear member 1220 to transmit sounds to the ear of the user. FIG. 14 additionally illustrates a microphone device 1234 positioned at a distal end of the extended microphone member 1350 and the charging connector member 1226 which extend from the bottom of the housing member 1224 of the detachable Bluetooth device 1202 to the front of the housing member 1224.

FIG. 15 illustrates a back view of the detachable Bluetooth device 1202 and shows the charging connector member 1226 extending from the bottom of the housing member 1224 to the back of the housing member 1224. The extended microphone member 1350 may be rigid or flexible. FIG. 15 additionally illustrates a activation device 1540 to activate the detachable Bluetooth device 1202 for communication with the cell phone device 104.

FIG. 16 illustrates a side view of the detachable Bluetooth device 1202 and shows the activation device 1540, the housing member 1224 and the ear member 1220 with the front speaker member 1632. FIG. 16 additionally illustrates the connecting member 1222 for connecting the housing member 1224 to the ear member 1220. FIG. 16 additionally illustrates the outwardly extending projection 1630 on the side of the housing member 1224 to cooperate with the restraining device 518 of the cell phone device 104.

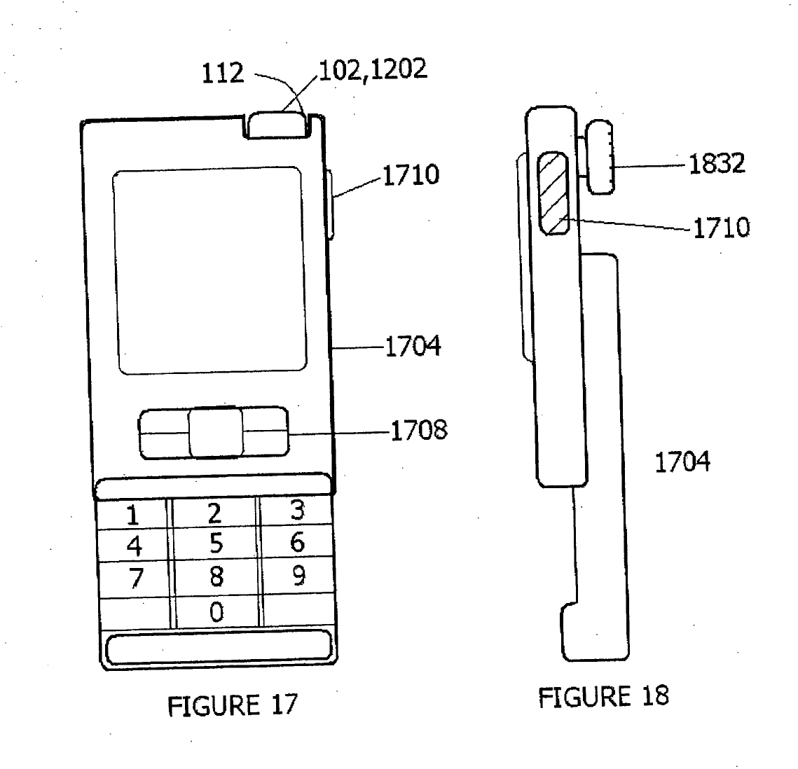

FIG. 17 illustrates a front view of a slide out type, cell phone device 1704 and shows the detachable Bluetooth device 102, 1202 positioned within the depression 112. FIG. 17 further illustrates the release device 1710 for releasing the detachable blue tooth device 102, 1202. FIG. 17 additionally illustrates the control panel 1708 for controlling the cell phone device 1704.

FIG. 18 illustrates a side view of the slide out type, cell phone device 1704 and shows the release device 1710 and the speaker member 1832.

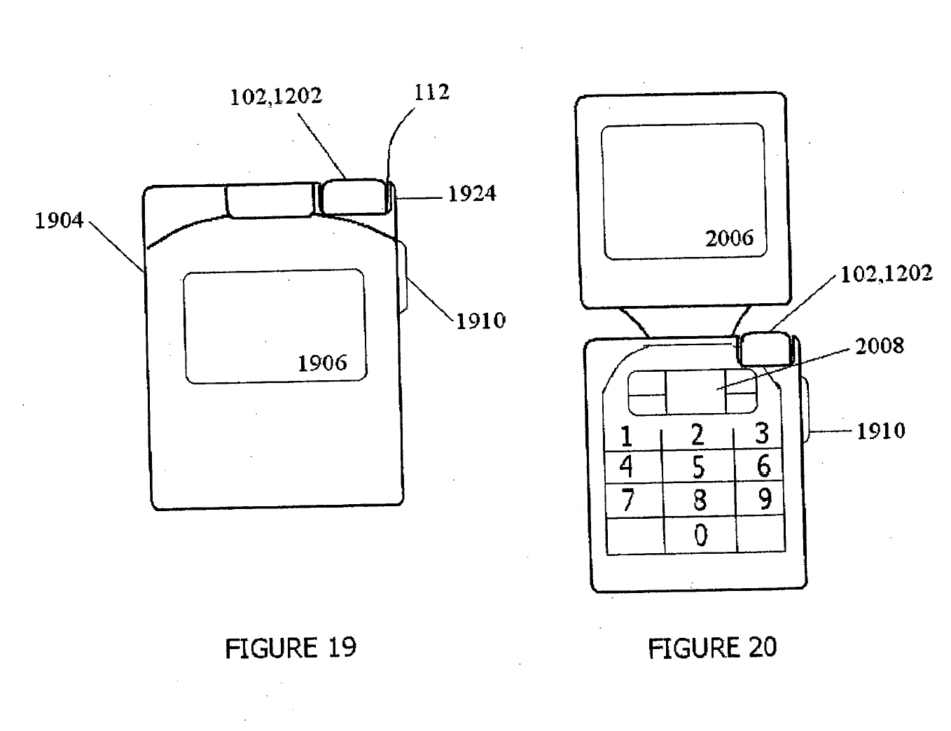

FIG. 19 illustrates the flip type, cell phone device 1904 in a closed position and shows the detachable Bluetooth device 102, 1202 positioned within the depression 112. FIG. 19 additionally illustrates the release device 1910 for releasing the detachable Bluetooth device 102, 1202 positioned along the side of the housing member 1924. FIG. 19 illustrates an external screen 1906 positioned on the front of the housing member 1924 for displaying information.

FIG. 20 illustrates the flip type, cell phone device 1904 in an open position and shows the detachable Bluetooth device 102, 1202 positioned within a depression 112. FIG. 20 shows an internal screen 2006 to display information and shows the release device 1910 for releasing the detachable blue tooth device 102, 1202. Additionally, FIG. 20 shows the control panel 2008 to control the functions of the flip type, cell phone device 1904.

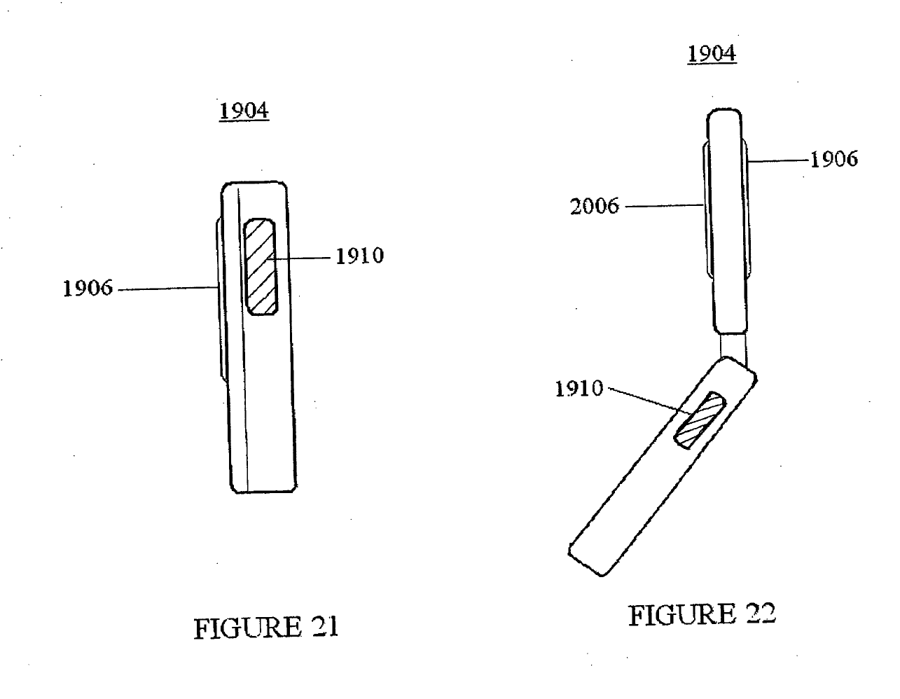

FIG. 21 illustrates a side view of the flip type, cell phone device 1904 in a closed position. FIG. 21 shows the external screen 1906 and the release device 1910 for releasing the detachable Bluetooth device 102, 1202.

FIG. 22 illustrates the side view of the flip type, cell phone device 1904 in an open position. FIG. 22 shows the exterior screen 1906 and the interior screen 2006 for displaying information relating to the cell phone device 1904 and the detachable Bluetooth device 102, 1202.

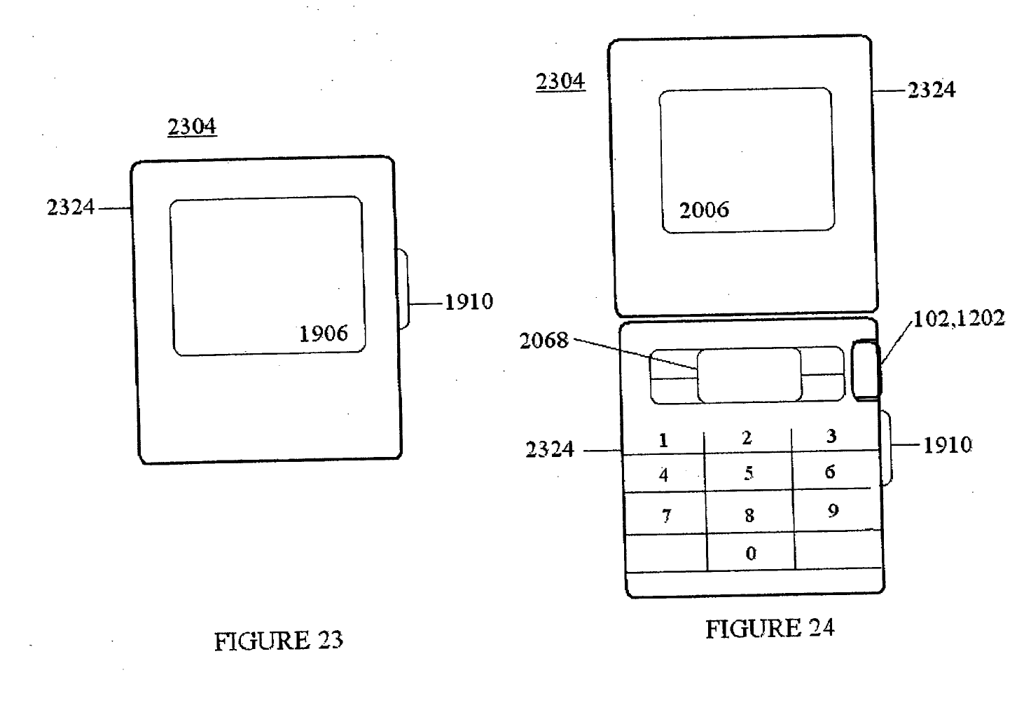

FIG. 23 illustrates a front view of a flip type, cell phone device 2304 in the closed position with the detachable Bluetooth device 102, 1202 mounted in the side of the housing member 2324. FIG. 23 illustrates exterior screen 1906 and the release device 1910.

FIG. 24 illustrates a front view of the flip type, cell phone device 2304 in the open position with the detachable Bluetooth device 102, 1202 mounted in the side of the housing member 2324. FIG. 24 shows the interior screen 2006 and the control panel 2068.

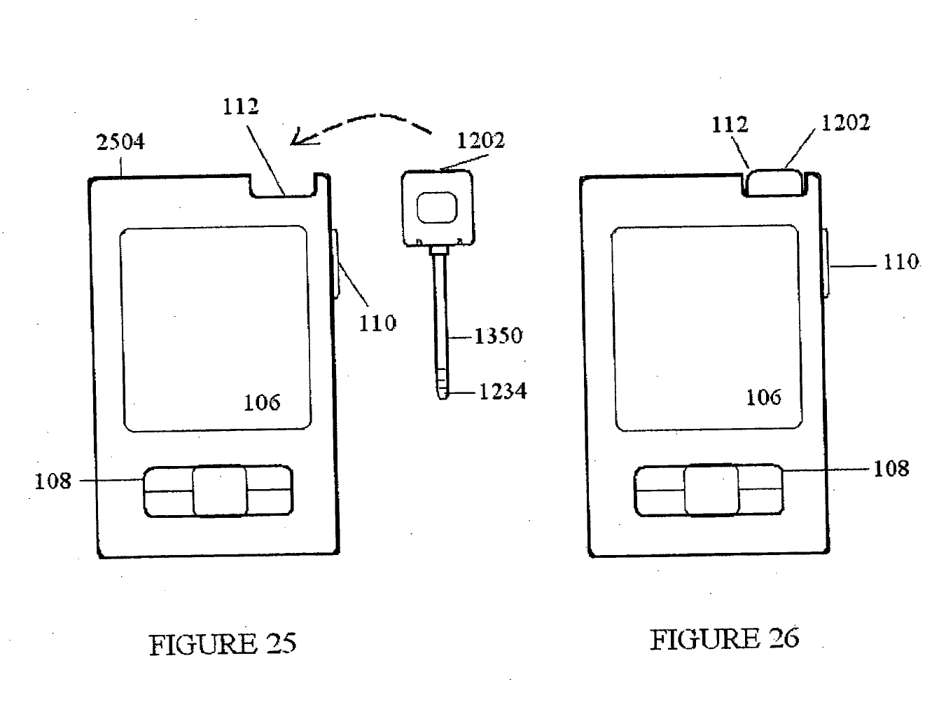

FIG. 25 illustrates the front view of a cell phone device 2504 with a detachable Bluetooth device 1202 having an extended microphone member 1350 with a microphone device 1234 at the distal end of the extended microphone member 1350. FIG. 25 shows that the detachable Bluetooth device 1202 has been removed from a depression 112 of the cell phone device 2504. FIG. 25 shows a control panel 108, a screen 106 and a release device 110 which will release the detachable Bluetooth device 1202 upon activation.

FIG. 26 illustrates the front view of the cell phone device 2504 with the detachable Bluetooth device 1202 positioned in the depression 112 of the cell phone device 2504. The detachable Bluetooth device 1202 can be removed by pressing the activation device 110. FIG. 26 illustrates the screen 106 and a control panel 108.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device for wireless communication, comprising:
a cell phone device for wireless communication;
a Bluetooth device for wireless communication with the cell phone device;
wherein the Bluetooth device is detachedly connected to the cell phone device.

2) A device for wireless communication as in claim 1, wherein the cell phone device includes a restricting device to hold the Bluetooth device.

3) A device for wireless communication as in claim 2, wherein the Bluetooth device includes an outwardly extending projection to cooperate with the restraining device.

4) A device for wireless communication as in claim 2, wherein the cell phone device includes a release device to release the Bluetooth device by cooperating with the restraining device.

5) A device for wireless communication as in claim 1, wherein the Bluetooth device includes an ear member.

6) A device for wireless communication as in claim 1, wherein the cell phone device includes a depression for holding the Bluetooth device.

7) A device for wireless communication as in claim 5, wherein the Bluetooth device includes a housing member.

8) A device for wireless communication as in claim 7, wherein the Bluetooth device includes a connecting member for connecting the housing member with the ear member.

9) A device for wireless communication as in claim 1, wherein the Bluetooth device includes a microphone device.

10) A device for wireless communication as in claim 1, wherein the Bluetooth device includes a front speaker member.

11) A device for wireless communication as in claim 1, wherein the cell phone device includes charging connector.

12) A device for wireless communication as in claim 11, wherein the Bluetooth device includes a charging connection member for cooperating with the charging connector of the cell phone device.

13) A device for wireless communication as in claim 1, wherein the cell phone device includes a control panel.

14) A device for wireless communication as in claim 1, wherein the cell phone device includes an internal screen.

15) A device for wireless communication as in claim 1, wherein the cell phone includes an external screen.

16) A device for wireless communication as in claim 1, wherein the cell phone is a flip type.

17) A device for wireless communication as in claim 1, wherein the Bluetooth device includes a extended microphone member.
